(19) United States
(12) Patent Application Publication
(10) Pub. No.: US 2008/0073816 A1
(43) Pub. Date: Mar. 27, 2008

(54) METHOD FOR FORMING A GEAR

(76) Inventors: Stephan Oberle, Villingen-Schwenningen (DE); Stefan Hoch, Titisee-Neustadt (DE); Norbert Willmann, Eisenbach (DE)

Correspondence Address: Patrick J. O'Shea, Esq.;Gauthier & Connors LLP, Suite 3300, 225 Franklin Street, Boston, MA, 02110, US

(21) Appl. No.: 11/933,717

(22) Filed: Nov. 1, 2007

Related U.S. Application Data
(62) Division of application No. 10/744,588, filed on Dec. 23, 2003.
(60) Provisional application No. 60/515,622, filed on Oct. 30, 2003.

(51) Int. Cl. B29C 45/00

(52) U.S. Cl. 264/328.14; 264/328.1

(57) ABSTRACT

The invention relates to a gear composed of an injection-molded material, comprising an internal gate region and an external toothed ring with teeth, wherein each tooth has an external tooth crest and two lateral tooth base segments, at least one locating hole for a driver element engaging from the side, and a weld line of the injection-molded material, wherein the weld line runs from an external wall of the locating hole to the outer circumference of the gear, wherein the weld line runs through the tooth crest of one of the teeth to the outer peripheral surface of the tooth. In addition, an injection-molding method is proposed for the injection molding of such a gear. Due to the path of the weld line through the gear body to the periphery of the tooth, tensile stresses are distributed along a greater distance than is the case in a conventional gear.

### PRIORITY INFORMATION

This application is a divisional of co-pending U.S. application Ser. No. 10/744,588 filed on Dec. 23, 2003, and which is hereby incorporated by reference.

### BACKGROUND OF THE INVENTION

The invention relates to the field of gears, and in particular to a gear composed of an injection-molded material, and to an injection-molding method for the injection molding of a gear using an injection-molding material.

Prior art publication WO 02/38432 A1 (DE 100 56 133 A1), incorporated herein by reference, discloses a steering device for motor vehicles having a gear system. The gear system includes a worm gear inserted between a first and second flange. Driver elements project from the first flange and are removed from the central rotational axis of this flange towards the second flange. The driver elements pass through locating holes of corresponding shape formed in the gear. In this gear system, a worm gear of a steering linkage engages the teeth of a toothed ring around the outer circumference of the gear.

Gears of this type are often fabricated from an injection-molded plastic material using an injection-molding method. FIG. 2 shows a gear 200 fabricated by the injection-molding method of the prior art. A central passage 202 passes through the center of the body of the gear 200. Facing this central passage 202, the body of the gear has a wall that delimits an inner circumference 203. On its exterior, the gear 200 has a toothed ring 204 having a plurality of teeth (e.g., 206-210). Each tooth is in the form of an external tooth crest 212 and a tooth base with two lateral tooth base segments 214, 25. Viewed from the outer circumference of the gear 200 the lateral tooth base segments 214, 215 form the lowest indentation points between the individual teeth. Locating holes 218 pass through the body in the region between the inner circumference 203 and the toothed ring 204. Each locating hole 218 provides for the insertion of a driver element that passes from a flange located laterally relative to the first gear 200 through the locating hole 218 to an opposing lateral flange. The locating holes 218 are longitudinally extended in the circumferential direction, this extension preferably being larger than the width of the inserting driver elements.

The gear 200 shown was fabricated using the injection-molding method. The gear 200 has an extremely thick-walled structure so that it can support the high loads required in the gear system. For the purpose of carrying the torque, the component has six locating holes 218 of this type in the form of holes through the body of the gear 200. The central passage 202 or inner circumference 203 of the gear 200 serves as the gate or sprue region for the injection-molded material during the injection-molding operation. The central sprue of the worm gear that is formed by the gear, is thus located at the center of the gear. The expanding flow of injection-molded material flows around the holes or locating holes from the inside out, thus forming behind them (i.e., behind the locating holes) one secondary weld line 230 each. However, it is also possible to employ other sprues, specifically multiple sprues.

Each of the weld lines 230 presents a disadvantage in terms of a weakening of the material since the weld line is formed by a confluence of the melt fronts with cooled surfaces. According to the textbook, i.e., based on the ordinary knowledge of an individual skilled in the art, the greatest wall thickness should be located in the region of the sprue, while the smallest material thickness should be located at the end of the flow path for the injected material to enable the holding pressure to act through to the end of the flow path, thereby avoiding vacuoles or bubbles, i.e., cavities. In prior-art gears fabricated in this way, the tooth base is thus located precisely at the end of the flow path in the confluence region.

A disadvantage is that the highest load is generated during the transmission of torque at the base of the teeth. As a result, in the region of the lateral tooth base segment 215 in which the weld line 230 terminates, a tensile stress A acts on the weld line. In addition, the torque carrying action of the driver element passing through the holes produces additional tensile stresses B in the region of the holes which act on the inside end of weld line 230. The superimposition of the two loads, i.e., of the two tensile stresses A, B, disadvantageously generates the highest stresses precisely in the region of secondary weld line 230. In response to high loads, a gear of this type thus breaks at weld line 230.

### SUMMARY OF THE INVENTION

The goal of the invention is to provide an improved gear which has greater strength in the region of preferably each individual weld line.

In addition, the position of the weld line should run the longest distance possible between a locating hole for a driver element and the outer circumference of the gear so as to distribute a tensile stress acting on the weld line over the greatest possible distance.

An additional goal is to propose an injection-molding method which provides for the injection molding of such a gear.

In one embodiment, a gear is produced from an injection-molded material and comprises a central passage and an outer toothed ring with teeth. Each of the teeth has a tooth crest and two lateral tooth base segments. A plurality of locating holes are provided to receive one laterally engaging driver element each, wherein the locating holes are situated in a region of the gear body between its central passage and its outer circumference. A weld line of the injected material is located between an outer wall of each locating hole and the outer circumferential surface of the gear, wherein each weld line runs radially at the center from the corresponding locating hole through one of the adjacent teeth to the center outer circumferential surface of the tooth crest.

A gear is composed of injection-molded material and comprises one or more interior sprue regions and an outer toothed ring with teeth, wherein each tooth has an external tooth crest and two lateral tooth base segments. At least one locating hole for a driver element engaging from the side, and a weld line of injection-molded material, wherein the weld line runs from one outer wall of the locating hole to the outer circumference of the gear. The weld line runs through the gear crest of one of the teeth to its outer peripheral surface. A passage which runs completely through the body, instead of a locating hole which has been created so as to enter only partially into the body.

Advantageously in a gear of this type, the weld line terminates in the center region of the outer circumferential surface.

Advantageously in a gear of this type, the weld line is removed from the lateral base segments of the gear and runs into and through the tooth starting from the body of the gear.

Advantageously in a gear of this type, the weld line runs from a center segment of the outer wall of the locating hole to the outer circumferential surface.

Advantageously in a gear of this type, viewed in the circumferential direction, the center of the locating hole coincides with a center section of the tooth oriented radially relative to the hole, through which tooth the weld line runs.

Advantageously in a gear of this type, viewed in the circumferential direction, the center of the locating hole coincides with a center of the tooth oriented radially relative to the hole, through which tooth the weld line runs.

Advantageously, a gear of this type is designed with a central passage which forms the sprue region. Alternatively, however, multiple sprue regions may also be provided.

Advantageously in a gear of this type, the locating hole is situated in the center region between a central axis and the outer circumference of the gear body.

Advantageously in a gear of this type, the number of teeth divided by the number of locating holes produces a number of the set of integers.

Advantageously in a gear of this type, the gear is injection-molded from an injection-molding plastic material.

Advantageously, an injection-molding method for the injection molding of a gear uses an injection-molding material in a mold, wherein a mold is employed which has an injection-molding-material-receiving recess in the form of the gear with external teeth and a central sprue region and having inclusions around which the injection-molding material is to flow so as to form locating holes or passages through the gear body. The inclusions are oriented relative to the teeth and gate region in such a way that a weld line of the injection-molding material flowing around one of the inclusions runs in an external direction at the center through an adjacent tooth to the periphery of the tooth.

Advantageously in an injection-molding method of this type, a plastic injection-molding method is employed for injection molding.

Advantageously, a coincidence of extreme tensile stresses no longer occurs at the tooth base, nor does any total material weakening occur in the region of the weld line, since the weld line has been displaced away from the lateral tooth base segment. The weld line is thus no longer located at the weakest point of the component or gear, since the unit load is significantly reduced due to the greater cross-sectional area in the tooth as compared with a conventional gear having a weld line terminating at the lateral tooth base segment. As a result, a gear of this type supports a significantly greater load before breaking at the tooth base. Higher transmission forces are thus advantageously possible within the same installation space.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates a gear in which the weld line runs from a locating hole for a driver element in a radially external direction at the center through an adjacent tooth;

FIG. 2 illustrates a prior art gear wherein the weld line terminates in the lateral tooth base segment; and

FIG. 3 shows a gear system of the prior art for mounting a gear of this type between lateral flanges having driver elements which pass through the locating holes in the gear.

### DETAILED DESCRIPTION OF THE INVENTION

The following describes an embodiment which incorporates by reference the disclosure content of the United States Provisional patent application of Stephan Oberle, Norbert Willmann, and Stefan Hoch for a gear, dated Oct. 30, 2003, the priority of which is claimed here—to include modifications and variations understood by an individual skilled in the art.

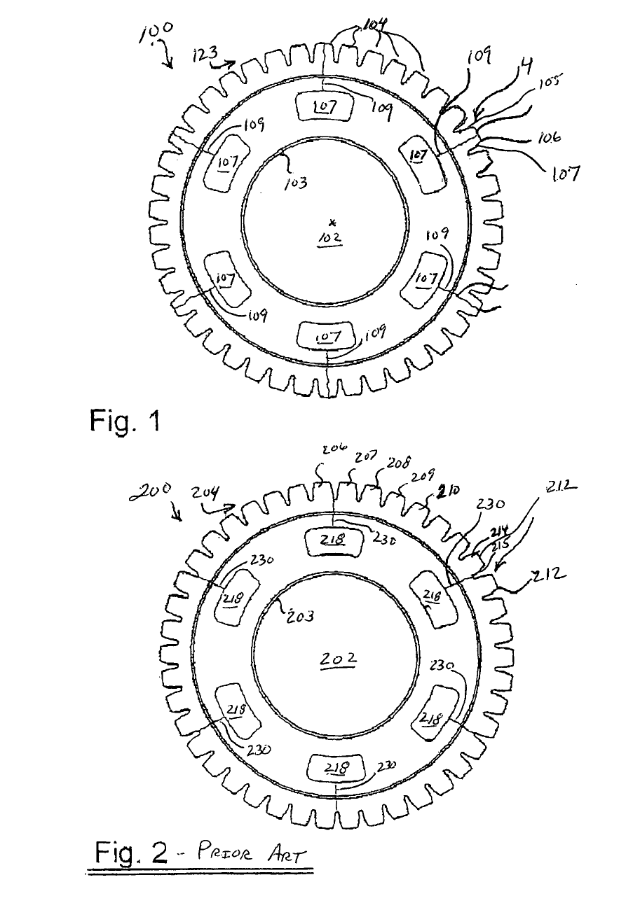

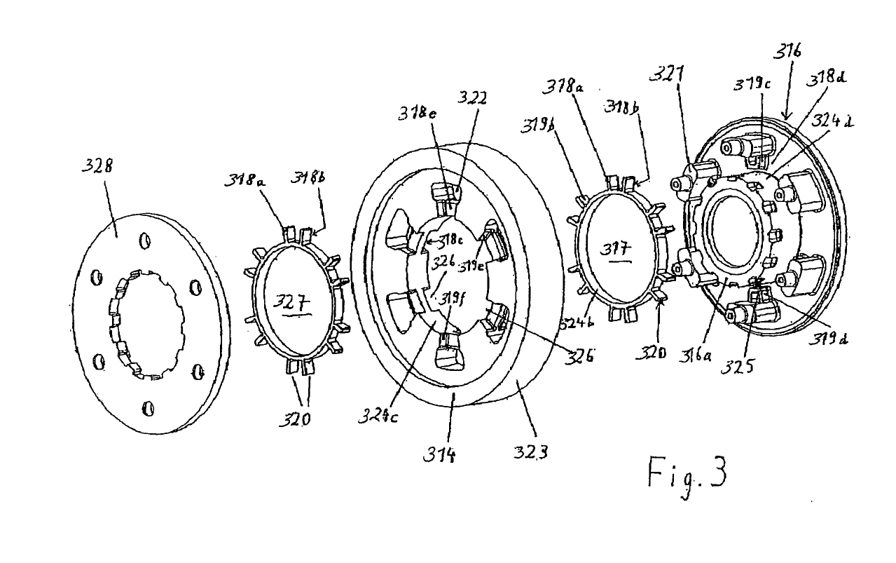

FIG. 3 is an exploded view of an elastic compensating coupling known from Bernhard et al., of which worm gear 314 of FIG. 2 forms a part. The worm gear 314 is preferably in the form of a gear 100 according to FIG. 1.

The worm gear 314 has a toothed ring 323, wherein the teeth engaging a worm are not shown. The other coupling component of the elastic compensating coupling, specifically a flange 316, is rotationally attached to an input shaft (not shown) the connection being effected by a stub having a front surface 316a and a circumferential surface 324d.

Added on to the two components, the gears 314 and the flange 316, of the compensating coupling are an annular elastic spacer 317 having extensions 320. In the installed state, an inner surface 324b of the spacer 317 abuts the circumferential surface 324d of the stub of the flange 316. Two extensions 320 each encompass one of the cogs 325 on the flange 316.

The worm gear 314 has a mirror-symmetrical design, i.e., the nonvisible reverse side has the same appearance as the front side. After assembly, the worm gear 314 abuts the spacer 317 which in turn abuts the stub of the flange 316. In other words, an inner surface 324c of the worm gear 314 abuts an annular outer surface 324a of the spacer 317. Salients 326 of the recesses 322 are provided in the worm gear 314 for the extensions 320 of the spacers 317. Extensions 320 are accommodated within these salients 326.

Although it is possible that the worm gear 314, the flange 316 and the spacer 317 would be sufficient to fulfill the function of an elastic compensating coupling, the front side of the worm gear 314 is augmented by a second spacer 327 and a second flange 328 to form a second compensating coupling. In the installed state, the flanges 316 and 328 are interconnected by driver elements or dogs 321. In addition, the inner teeth of the second flange 328 engage the teeth of the stub on the flange 316. In the installed state, the second elastic spacer 327 also abuts the stub of the flange 316. The rear side of the second flange 328 has the same cogs 325 as does the flange 316. These cogs of the second flange 328 each project into the area between the closely spaced extensions 320 of the spacer 327.

For example, a front contact surface 318a of the second spacer 327 then abuts the rear face of the second flange 328. A rear contact surface 318b of the second spacer 327 abuts a contact surface 318e of a salient 326 in the worm gear 314. Lateral contact surfaces 319a, 319b of the spacers 317 or 327 abut lateral contact surfaces 319c, 319d of the cog 325 or against the lateral contact surfaces 319e, 319f of the salients 316 in the worm gear 314.

The extensions 320 thus prevent the cogs 325 from directly touching the lateral surfaces of the salients 326 during the transmission of torque in one or the other direction. The spacers 317, 327 are sufficiently wide that they prevent direct contact of the worm gear 314 and the flange 316, or of the worm gear 314 and the second flange 328, in the axial direction. Since the annular components of the spacers 317, 327 are situated between the circumferential surface 324d of the flange 316 and the inner surface 324c of the worm gear 314, the configuration ensures that even in the radial direction any direct contact between the stub of the flange 316 and the worm gear 314 is prevented. Both in the axial and radial directions, and ultimately also in the tangential direction, the spacers 317, 327 thus form a buffer between the flange 316, and thus the input shaft, on the one side, and the worm gear 314 on the other.

The elastic buffering is, however, not unlimited in the tangential direction since the recesses 322 in the worm gear 314 through which the dogs 321 of the flange 316 engage are only slightly larger in the tangential direction than the dogs 321. As a result, the dogs 321 and the recesses 322 create interdependent stops which come into effect when the extensions 320 of the spacers 317, 327 are pressed together by a predetermined amount during transmission of an excessive torque.

FIG. 1 shows gear 100 which may be employed as a worm gear, for example, in a gear system illustrated in FIG. 3. It is of course possible to employ the gear 100 in other gear system configurations.

A central passage 102 passes through the center of the body of the gear 100. Facing this central passage 102, the body of the gear has a wall which delimits the inner surface or inner circumference 103. On its exterior, the gear 100 has a toothed ring 123 having a plurality of teeth 104. Each tooth 104 is in the form of an external tooth crest 106 with a tooth base and with two lateral tooth base segments 105, 107, respectively. Viewed from the outer circumference of the gear 100, the lateral tooth base segments 105, 107 form the tooth notch, i.e., the lowest indentation point between the individual teeth 104.

Locating holes 107 pass through the body in the region between inner circumference 103 and the toothed ring 123. Each locating hole 107 provides for the insertion of a driver element which passes from a flange located laterally relative to first gear 100 through the locating hole 107 to an opposing lateral flange. Alternatively, the recesses may be designed so as to enter only partially into the body of the gear 100.

The locating holes 107 are of an extended form in the radial, i.e., circumferential direction, this extension preferably but not necessarily being larger than the width of the inserting driver elements.

The gear 100 shown was fabricated using the injection-molding method. The gear 100 as a component has an extremely thick-walled structure in order to be able to support the high loads required in the gear system. For the purpose of carrying the torque, the component has six such locating holes 107 in the form of holes through the body of the gear 100. The central passage 102 or the inner circumference 103 of the gear 100 serves as the gate region or sprue region for the injection-molded material during the injection-molding operation. The central sprue of the worm gear, which is formed by the gear, is thus located at the center of the gear. However, it is also possible to employ multiple sprues. The expanding flow of injection-molded material surrounds the holes or locating holes from the inside out, thus forming behind these, i.e., behind the locating holes, one secondary weld line 109 each.

Proceeding from a radially external wall of each of the locating holes 107, a weld line 109 runs in a radially external direction to the outer circumference of the gear 100. The weld line 109 here preferably runs at the center through a tooth 104 adjacent to the locating hole 107 to the tooth crest 106. The weld line 109 thus extends over a distance which is greater than the distance from the radially outer wall of the locating hole to the lateral tooth crest segment 105 between two adjacent teeth. As a result, the tensile forces acting on the weld line act over a comparatively extended distance distributed along the weld line.

In an especially preferred embodiment, the gear 100 has the central passage 102 which is designed as the sprue region for the injection-molding material. Alternatively, the gear 100 may also be in the form of a solid body, although the injection of the injection-molding material nevertheless proceeds from a central point in the region of a rotational axis of the gear 100.

In an injection-molding method for the injection molding of the gear 100 using injection-molding material, a mold is employed which has an injection-molding-material receiving recess in the form of the gear with the external teeth 104 and a central gate region and having inclusions around which the injection-molding material is to flow so as to form locating holes for a driver element through the gear body. The inclusions are oriented relative to the teeth and gate region in such a way that the weld line 109 of the injection-molding material flowing around one of the inclusions runs through an adjacent tooth 104 to the periphery of the tooth.

In an alternative embodiment having a sprue region not precisely centered, the weld line 109 may be formed so as to be offset in a lateral direction from the center of the locating hole 107. In this case, the teeth along the outer circumference are accordingly arranged relative to the corresponding locating holes so that the weld line again runs from the external wall of the locating hole 107 at the center through the adjacent tooth 104.

In the embodiment shown, the gear 100 has a total of forty-two (42) teeth 104 and a total of six (6) locating holes 107, i.e., there are seven times as many teeth as locating holes. In addition, other, specifically, whole-number ratios of locating holes to teeth may be advantageously implemented.

Although the present invention has been illustrated and described with respect to several preferred embodiments thereof, various changes, omissions and additions to the form and detail thereof, may be made therein, without departing from the spirit and scope of the invention.

What is claimed is:

1. An injection-molding method for the injection molding of a gear using an injection-molding material in a mold, wherein a mold is employed which has an injection-molding-material receiving recess in the form of the gear with external teeth, having at least one gate region therein, and having inclusions around which the injection-molding material is to flow so as to form locating holes through the gear body, wherein the inclusions are oriented relative to the teeth and gate region in such a way that a weld line of the injection-molding material flowing around one of the inclusions runs in an external direction at the center through an adjacent tooth to the periphery of the tooth.

2. The injection-molding method of claim 1, wherein a plastic injection-molding method is employed for the injection-molding operation.

3. A method of forming a worm gear, comprising:
injecting heated plastic into a mold to form the worm gear comprising an outer toothed ring with radially exterior teeth, wherein each of the teeth has an external tooth crest and two lateral tooth base segments, and also a gear body and a plurality of circumferentially spaced locating holes to accommodate one laterally engaging driver element each, wherein the locating holes are co-axially situated in the gear body between a central passage and the outer circumference of the gear body, where the gear body comprises a weld line that extends radially outward from the circumferential exterior center of the locating hole to the center outer circumferential surface of the adjacent tooth.

4. The method of claim 3, where the central passage is a sprue region for the injection molded plastic.

5. The method of claim 4, where expanding flow of injection molded material surrounds the holes from the radially inside out to form the weld line.

6. The method of claim 5, where the step of injecting occurs at a plurality of sprues.
